(19) United States
(12) Patent Application Publication
(10) Pub. No.: US 2026/0070368 A1
(43) Pub. Date: Mar. 12, 2026

(54) UNPOWERED CRAYON SHAPER

(71) Applicant: Crayola LLC, Easton, PA (US)

(72) Inventors: Ying K. HO, Bethlehem, PA (US); Joseph MOLL, Bethlehem, PA (US); Robert HENRY, Bethlehem, PA (US)

(21) Appl. No.: 19/322,138

(22) Filed: Sep. 8, 2025

Related U.S. Application Data
(60) Provisional application No. 63/692,398, filed on Sep. 9, 2024.

(51) Int. Cl. B43K 19/00; B26D 3/08

(52) U.S. Cl. CPC B43K 19/00; B26D 3/08

(57) ABSTRACT

A crayon shaper having a housing which defines an opening for receiving heated air and a channel configured to receive a crayon. The channel is positioned so that the crayon is configured to be heated by the heated air entering the opening. A mold is positioned adjacent the channel and configured to receive portions of the crayon that are melted by the heated air. The housing may have a mold tray configured to retain the mold and detachably engage the housing. The housing may further have a shut-off plate that is biased to a closed position, in which it prevents melted portions of the crayon from entering the mold. The shut-off plate may be movable to an open position when the mold tray is inserted in the housing.

### CROSS-REFERENCE TO RELATED APPLICATIONS

This application is based on and claims priority to U.S. Provisional Application Ser. No. 63/692,398, filed on Sep. 9, 2024, which is incorporated herein by reference in its entirety.

### BACKGROUND

Crayons may be melted and reshaped. Existing crayon shapers require a power source and have internal circuitry which complicates manufacturing and increases cost.

### SUMMARY

A crayon shaper is disclosed having a housing which defines an opening for receiving hot air, a channel configured to receive a crayon to be melted by hot air from a hair dryer or similar heat source external to the crayon shaper, and a mold for reshaping the melted crayon.

In some embodiments, the housing may define an intake funnel defining the opening.

In some embodiments, the crayon shaper comprises a heat exchanger having an inner chamber for holding a crayon to be melted. The heat exchanger may have a plurality of fins located thereon for absorbing heat from hot air passing over them and transferring the heat to the inner chamber. The inner chamber may form a continuous connection to the channel, such that crayons inserted in the channel may fall to the inner chamber.

In some embodiments, the crayon shaper may comprise a mold tray for retaining the mold, wherein the mold tray may detachably engage the housing.

In some embodiments, the crayon shaper comprises a shut-off plate movable from an open position to a closed position, in which the shut-off plate prevents the flow of the portions of the crayon that are melted by the heated air from entering the mold. The shut-off plate is biased to the closed position and movable to the open position when the mold tray is inserted in the housing.

### BRIEF DESCRIPTION OF THE DRAWINGS

FIG. 1 is a perspective view of a crayon shaper in accordance with an exemplary embodiment of the invention described herein;

FIG. 2A is a rear perspective view of the crayon shaper of FIG. 1;

FIG. 2B is a rear perspective view of the crayon shaper of FIG. 1 with a mold tray detached;

FIG. 3 is a top view of the crayon shaper of FIG. 1;

FIG. 4 is a front elevation view of the crayon shaper of FIG. 1;

FIG. 5 is a rear elevation view of the crayon shaper of FIG. 1;

FIG. 6 is a side elevation view of the crayon shaper of FIG. 1;

FIG. 7 is a side elevation view of the crayon shaper of FIG. 1;

FIG. 8 is a cross-sectional view taken through the line 8-8 of FIG. 3;

FIG. 9 is a view similar to FIG. 8 showing the crayon shaper of FIG. 1 in use with a hair dryer;

FIG. 10 shows the crayon shaper of FIG. 1, crayons, molds, new molded parts resulting from use of the shaper, as well as the shaper in use with a hair dryer;

FIG. 11A is a perspective view of a crayon wrapper cutter of the crayon shaper of FIG. 1;

FIG. 11B is a top view of the crayon wrapper cutter of FIG. 11A;

FIG. 12A is a cross-sectional view similar to FIG. 8 showing a shut-off assembly in an open position;

FIG. 12B is a cross-sectional view similar to FIG. 12A showing the shut-off assembly in a closed position; and

FIG. 12C is a front elevational view similar to FIG. 4 showing a second entry screen in a closed position when the shut-off assembly is in a closed position.

### DETAILED DESCRIPTION

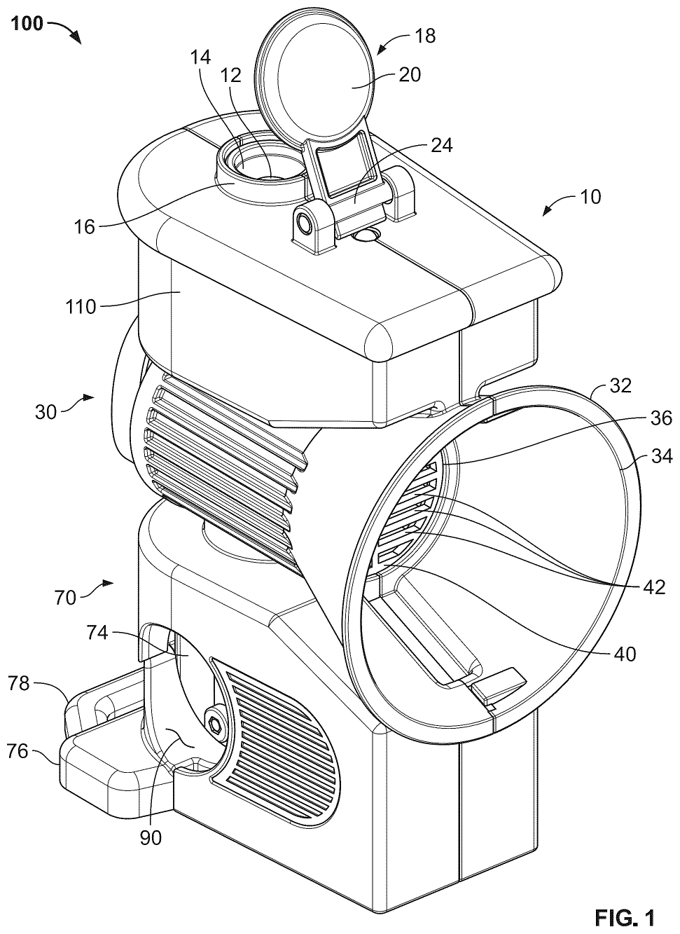

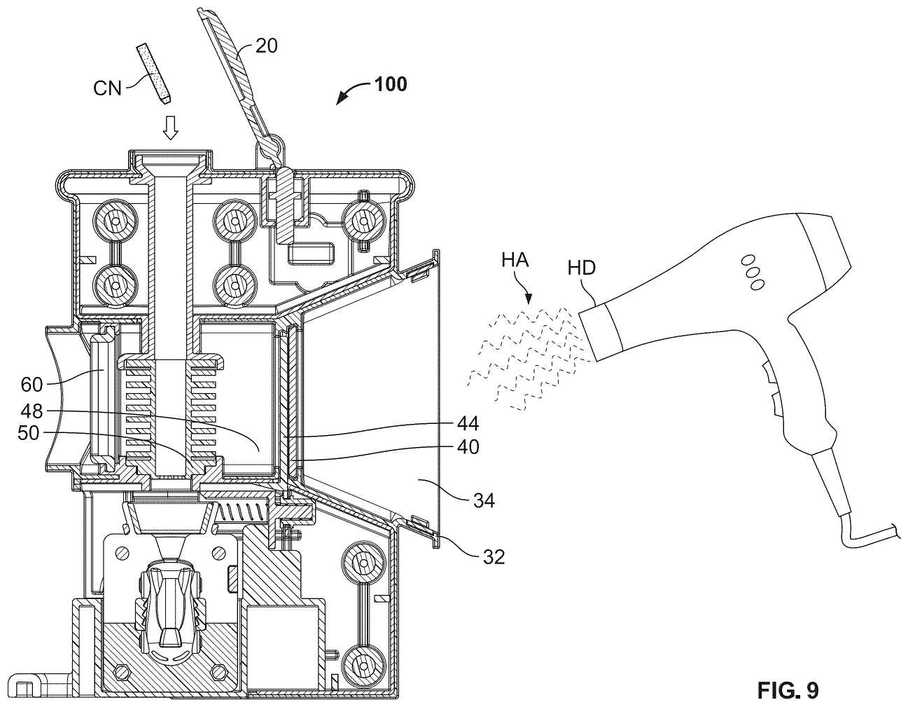

Referring to FIGS. 1-9, an unpowered crayon shaper 100 (herein after referred to as “the shaper”) is shown broadly comprising a housing 110, a mold 74, and a mold tray 76. The housing has an upper portion 10, a middle portion 30, and a lower portion 70. The shaper 100 is designed to facilitate the reshaping (e.g., molding) of crayons CN (FIG. 9) by melting crayons into the mold 74. The shaper 100 itself requires no power supply and is therefore simple and cost efficient to manufacture. The shaper 100 requires a source of hot air HA, for example a hair dryer HD as shown in FIG. 9, to melt crayons CN.

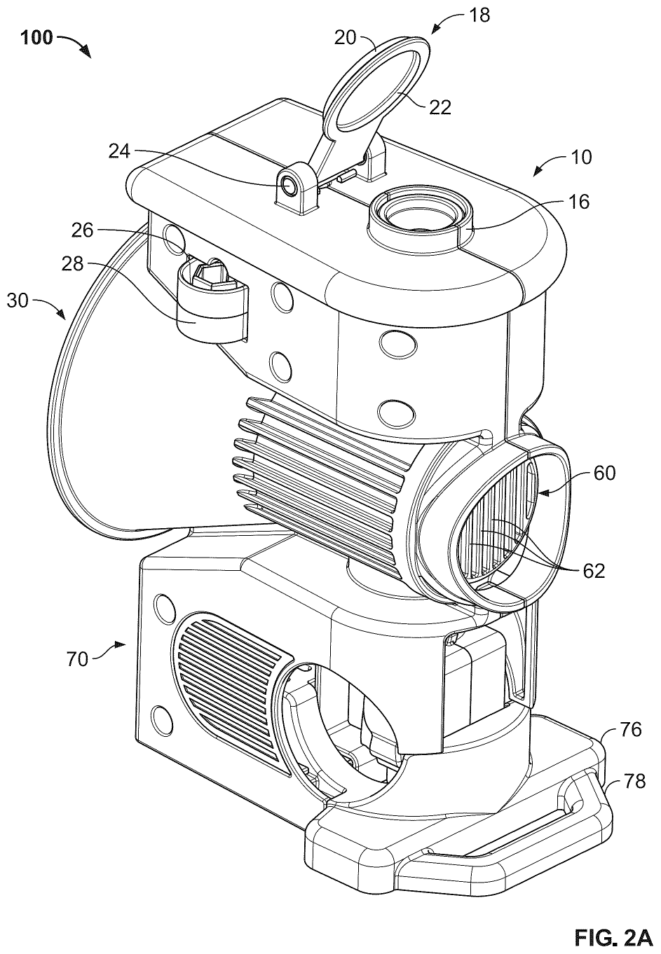

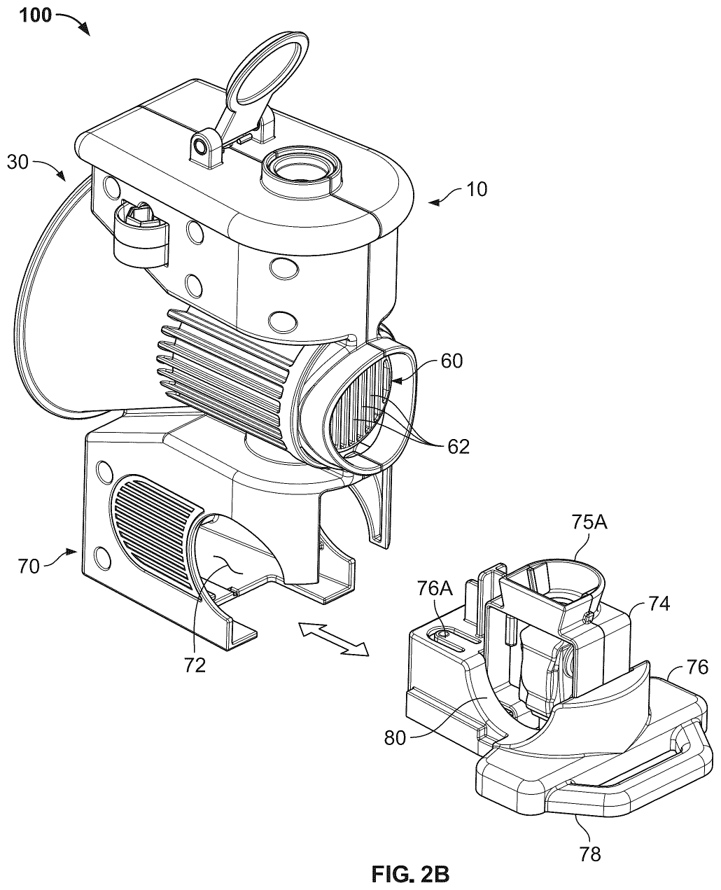

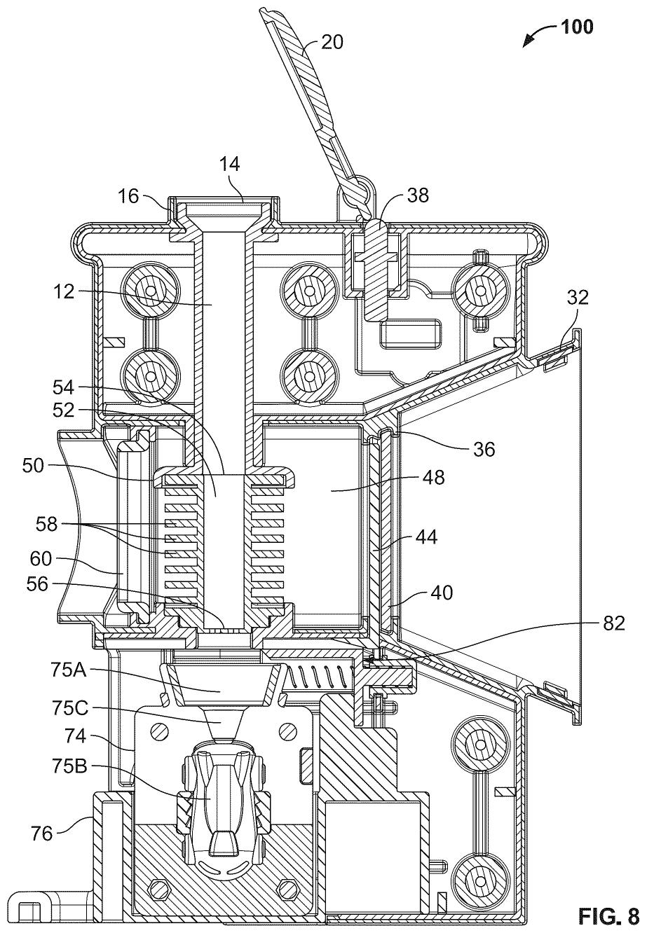

The upper portion 10 of the housing 110 will now be described with reference to FIG. 1. The upper portion 10 of the housing 110 broadly comprises a channel 12 and a lid assembly 18. The channel 12 is a vertically extending passageway shaped and sized to receive crayons CN into the shaper 100 and deliver them to the middle portion 30 for subsequent melting. The channel 12 has a channel mouth 14 with a channel lip 16 extending around the mouth 14. As can be seen from the cross section of FIG. 8, the channel lip 16 extends upwardly from a top surface of the housing 110 and defines the channel mouth 14 through which the channel 12 is accessible. The mouth has an upwardly facing conical geometry to make it easy for the user to position a crayon CN within the channel mouth 14 without error. Referring to FIG. 2A, the lid assembly 18 comprises a cap 20 having an annular recess 22 shaped and sized to receive the lip 16. The cap 20 is configured to move between a closed position blocking access to the channel mouth 14 and an open position allowing a user to insert a crayon through the channel mouth 14. The lid assembly 18 also comprises a hinge 24 for rotatably connecting the cap 20 to the top of the housing 110. In at least one embodiment, the hinge 24 has a biasing member, such as a spring, to retain the cap 20 in the closed position. This is so that, in the event that the shaper 100 is bumped, tipped over, or otherwise impacted, any contents of the channel 12 will not spill out through the channel mouth 14. For example, as shown in FIG. 8, a post 38 in contact with a rear portion of the cap 20 may be biased upward by a spring to force the cap 20 to its closed position when it is not being held in its open position by a user.

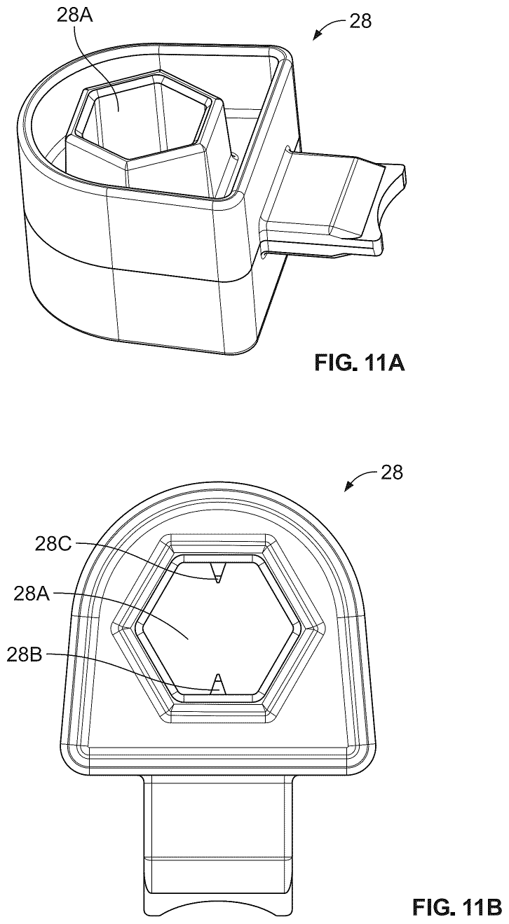

A recess 26 formed in a side wall of the upper portion 10 receives a crayon wrapper cutter 28. As shown in FIGS. 11A and 11B, a channel 28A extends through the crayon wrapper cutter 28 and is configured for receiving a crayon. Triangular protrusions 28B and 28C with pointed edges extend into the channel 28A. To remove a wrapper from a crayon, the crayon may be pushed through the channel 28A. As the crayon is pushed through the channel 28A, the protrusions 28B and 28C cut through the wrapper from one end of the crayon to the opposite end of the crayon. The wrapper may then be removed from the crayon. The crayon wrapper cutter 28 may be substantially the same as the wrapper removal mechanism described in U.S. Pat. No. 9,827,618 and U.S. Pat. No. 10,780,509 , each of which are hereby incorporated by reference herein.

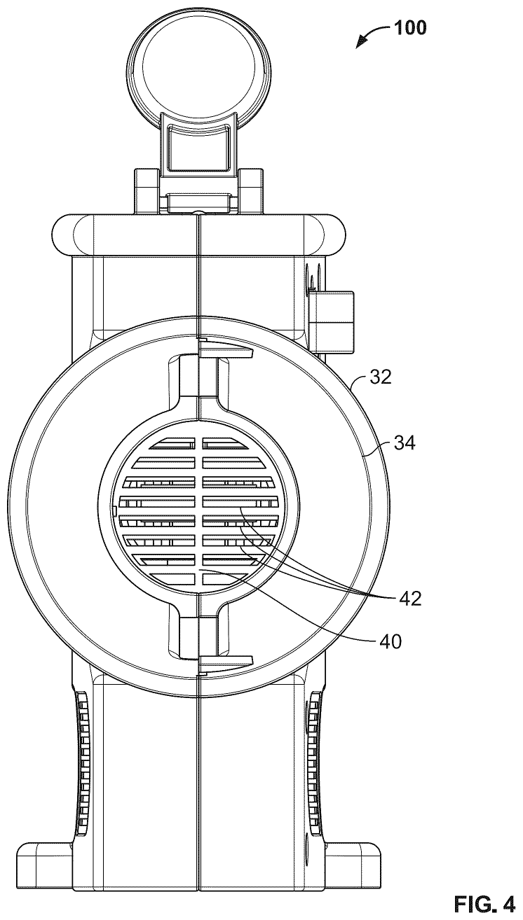

The middle portion 30 of the housing 110 will now be described in detail. As shown in FIG. 8, the middle portion 30 of the housing 110 broadly comprises an intake funnel 32 (hereinafter referred to as “the funnel”), first and second entry screens 40 and 44, an air guide 48, a heat exchanger 50, and an exit screen 60. As shown in FIG. 1, the funnel 32 defines a first opening 34 and a second opening 36. The first opening 34 has a wider diameter than the second opening 36. The first and second entry screens 40 and 44 are positioned adjacent the second opening 36, as shown in FIG. 8. As can be readily observed in FIG. 9, the funnel 32 is a front-mounted apparatus for guiding hot air HA from a hair dryer HD through the first opening 34, first and second entry screens 40, 44, and air guide 48 into contact with the heat exchanger 50, and out the exit screen 60. The funnel 32 assists in guiding the hot air HA into the housing 110. The first and second entry screens 40, 44 each define a plurality of horizontally extending slots 42, as shown in FIG. 4. When the second entry screen 44 is in an open position, as described below, the slots 42 of the entry screens 40, 44 are aligned allowing the passage of air through the second opening 36 and into contact with the heat exchanger 50. However, when the second entry screen 44 is moved to a closed position, as described below, the slots 42 of the entry screens are not aligned (i.e., the slots of each entry screen 40, 44 are blocked by the other entry screen 40, 44), thereby preventing the flow of air through the second opening 36 and into contact with the heat exchanger 50.

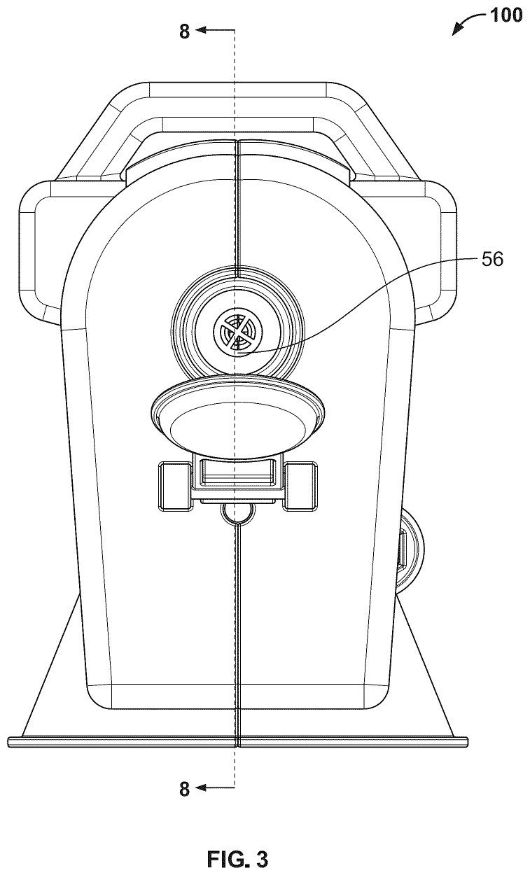

Referring to FIG. 8, the air guide 48 is positioned behind the second opening 36 when viewed from the funnel 32 and guides heated air into contact with the heat exchanger 50. The heat exchanger 50 comprises an inner chamber 52, a receiving opening 54, a drain 56, and a plurality of fins 58. The purpose of the heat exchanger 50 is to absorb heat from the hot air HA flowing through the air guide 48 and transfer the heat to a crayon CN positioned in the inner chamber 52 so that the crayon CN may melt. Optimal heat absorption is achieved by a plurality of annular fins 58 spaced vertically along and extending outwardly from a central body of the heat exchanger 50. The inner chamber 52 is designed to hold one crayon CN at a time, but may in some embodiments be modified to hold more than one crayon. The receiving opening 54 receives a crayon CN from the channel 12 and directs it into the inner chamber 52. The drain 56 is an opening located at the bottom of the inner chamber 52 and connects the space within the inner chamber 52 to the lower portion 70 of the housing 110. The primary purpose of the drain 56 is to allow the free flow of melted crayon (herein after referred to as wax) from the inner chamber 52 to a mold 74 in the lower portion 70 of the housing 110. As shown in FIG. 3, the drain 56 has a geometry (i.e., crossbars) which prevents solid crayons CN from falling downward into the lower portion 70.

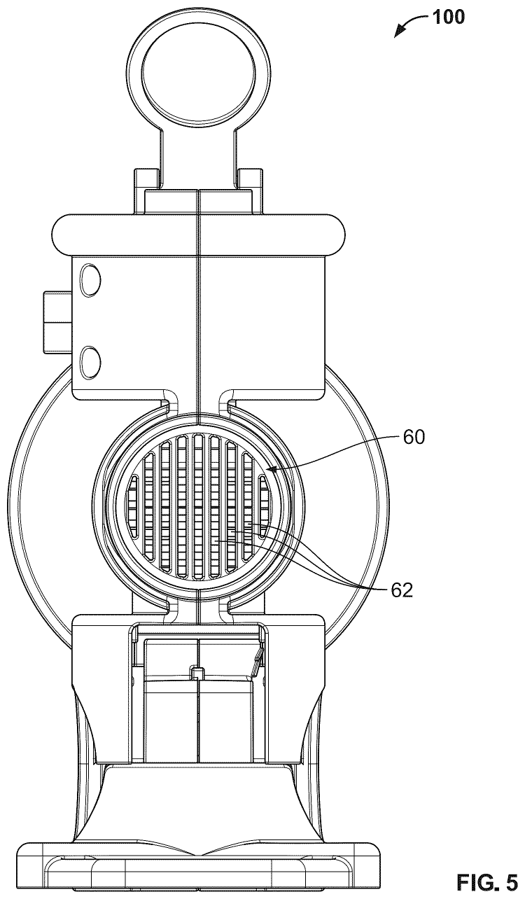

The exit screen 60 located at the rear of the air guide 48, as shown in FIG. 5, prevents a user from reaching into the air guide, and also prevents objects which may impede the free flow of air through the air guide from entering the air guide. The exit screen 60 defines a plurality of vertically extending slots 62 which allow air to exit the air guide 48 unimpeded.

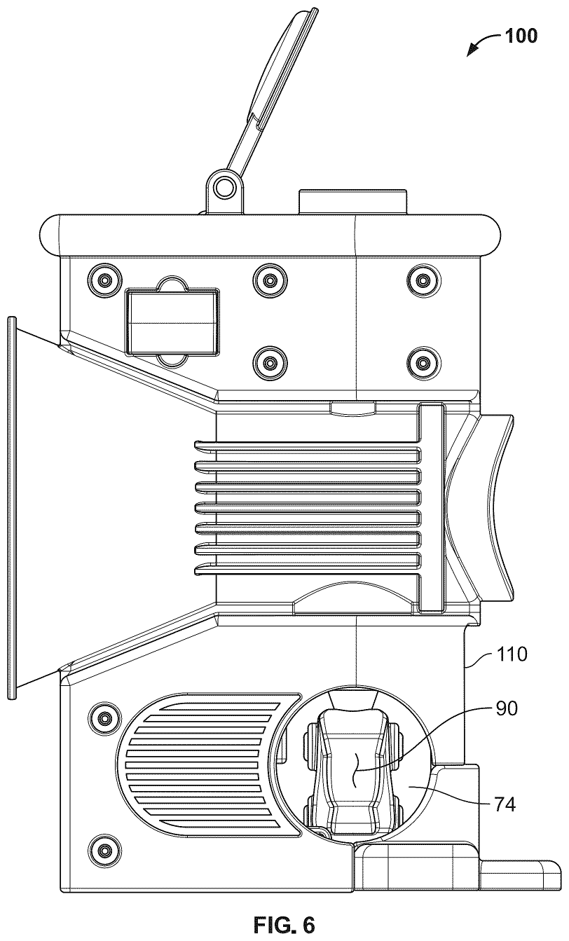

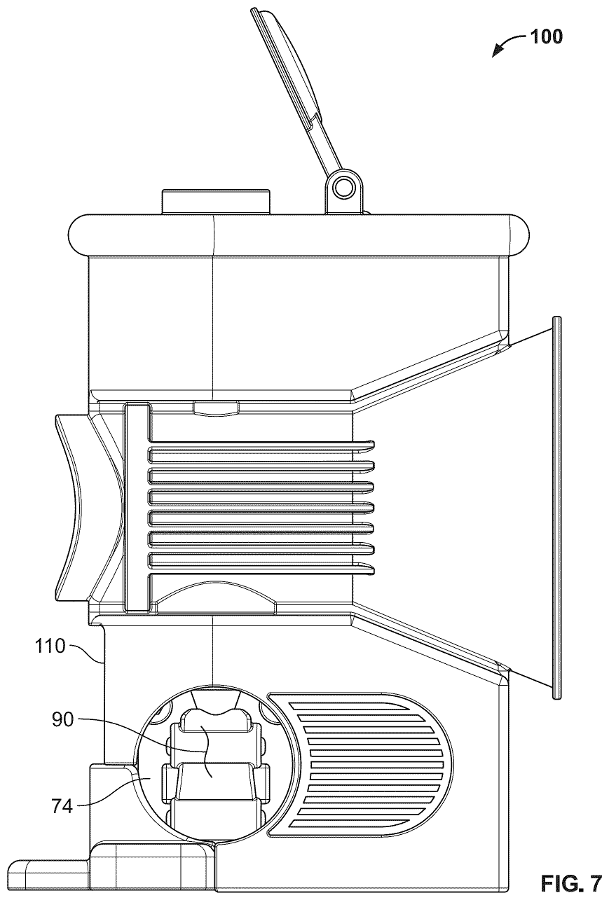

The lower portion 70 of the housing 110 will now be described in detail. The lower portion 70 broadly comprises a mold chamber 72 (FIG. 2B), shut-off assembly 82 (FIG. 8), and side openings 90 (FIGS. 6 and 7). As shown in FIG. 2B, the mold chamber 72 is a space defined by the housing 110 beneath the heat exchanger 50. The mold chamber 72 is specifically shaped and sized to releasably retain a mold tray 76 designed to hold a mold 74. The mold tray 76 has a tray handle 78 for facilitating the removal and insertion of the mold 74 and mold tray with respect to the mold chamber 72. The mold tray 76 is configured to latch within the housing 110 when inserted in the mold chamber 72 so that the mold tray holds the mold 74 directly under the drain 56 during use. For example, the mold tray 76 has flexible tabs 76A with protrusions that engage an internal structure of the housing 110 when the mold tray 76 is inserted in the mold chamber 72. The mold tray 76 has a mold holder 80 that is configured to retain the mold 74. The mold 74 itself comprises an exterior which corresponds in shape and size to the mold holder 80 of the mold tray 76.

Referring to FIG. 8, the mold 74 includes a mold cavity 75B and a mold funnel 75A. The mold cavity 75B is the portion of the mold 74 which determines the shape of the new molded part NM and holds the wax while it cools. For example, the mold cavity 75B has the shape of a car. The mold cavity 75B may define a number of shapes. Many different molds 74 can be purchased independently by a consumer and used with a single shaper 100 to minimize economic and material expense. The crayon shaper 100 may also come as a packaged kit with a number of different molds 74. The mold funnel 75A is an upwardly extending member on the exterior of the mold 74 which guides melted wax from the drain 56 into the mold cavity 75B via a mold channel 75C. The mold funnel 75A has a generally conical shape for receiving wax which may drip in a number of directions after exiting the drain 56. The mold funnel 75A doubles as a wax reservoir for retaining excess wax accumulated after the mold cavity 75B has been filled. After the wax has hardened into the new molded part NM, excess wax may be broken off and reused. The mold 74 is formed in two halves that may be separated from each other after the wax has hardened to remove the new molded part NM from the mold 74.

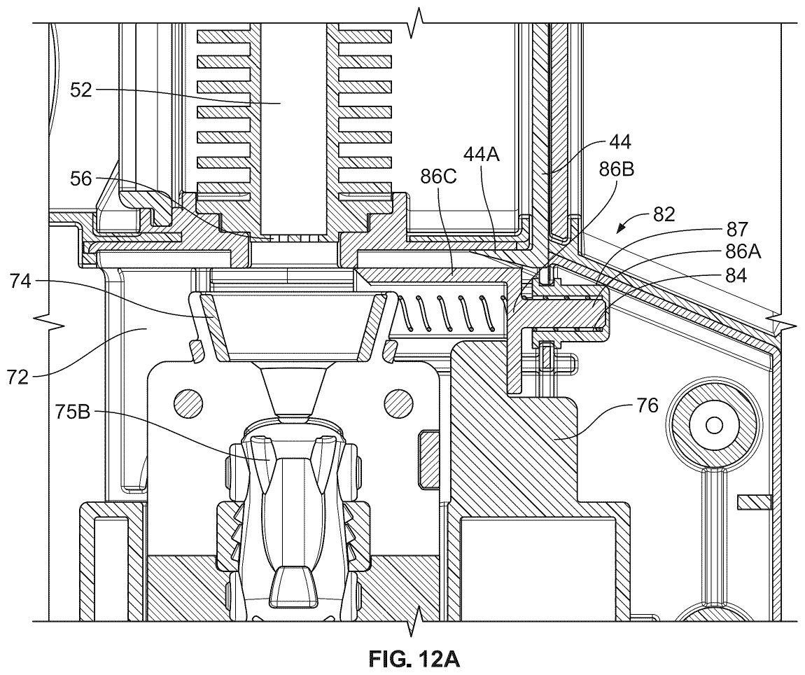

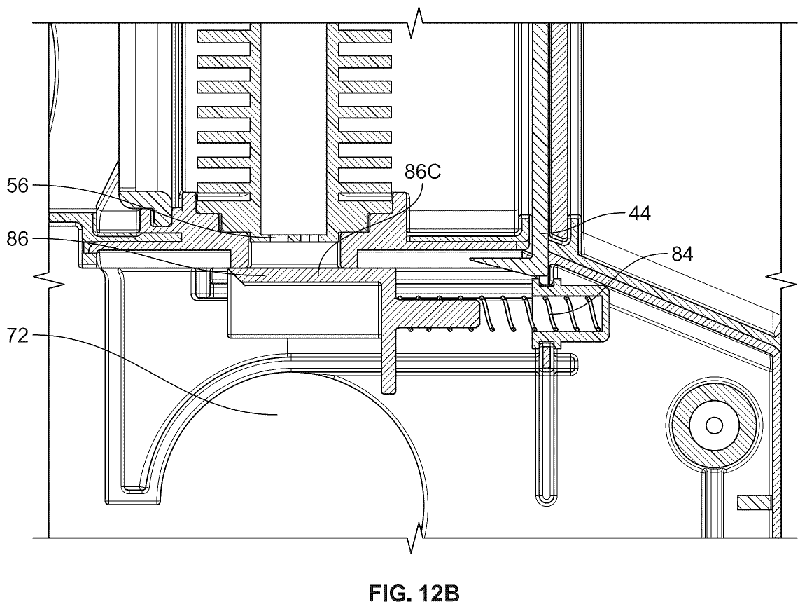

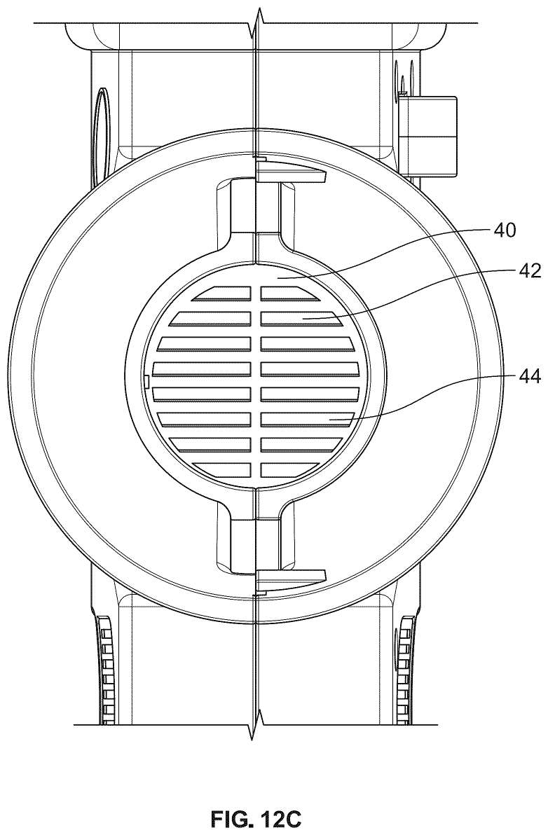

Referring to FIG. 12A, the lower portion 70 also comprises a shut-off assembly 82 designed to stop the flow of wax through the drain 56 when the mold 74 is not positioned thereunder. The shut-off assembly 82 comprises a spring 84 and a shut-off plate 86. When the mold tray 76 and mold 74 are positioned within the mold chamber 72 and the mold 74 is therefore beneath the drain 56, the mold tray 76 holds the shut-off plate 86 in an open position, as shown in FIG. 12A. In this position, the spring 84 is compressed and the shut-off plate 86 is retained at a position beside the drain 56 (open configuration), allowing the free flow of wax from the inner chamber 52 of the heat exchanger 50 to the mold cavity 75B. The shut-off plate 86 includes a protrusion 86A which extends through a middle of the spring 84, a vertical portion 86B from which the protrusion 86A extends, and a horizontal portion 86C extending from the vertical portion 86B. One end of the spring 84 is positioned within a spring retainer 87 of the housing 110 and the other end of the spring abuts the vertical portion 86B. The mold tray 76 engages the vertical portion 86B to force and maintain the shut-off plate 86 in the open position when the mold tray 76 is inserted in the mold chamber 72. Further, when the shut-off plate 86 is in the open position, the horizontal portion 86C engages and supports a lower angled surface 44A of the second entry screen 44 to maintain the second entry screen 44 in its open position as described above.

As shown in FIG. 12B, when the mold tray 76 is removed from the mold chamber 72, the spring 84 biases the shut-off plate 86 to the closed position, in which it blocks the flow of wax through the drain 56. The horizontal portion 86C of the shut-off plate 86 is positioned between the drain 56 and mold chamber 72 when the shut-off plate 86 is in its closed position. Further, when the shut-off plate 86 is in the closed position, the second entry screen 44 is no longer supported by the horizontal portion 86C of the shut-off plate. This causes the second entry screen 44 to drop to its closed position. In the closed position, the slots 42 (FIG. 4) of the first and second entry screens 40 and 44 are no longer aligned, as shown in FIG. 12C. This prevents hot air HA from entering the second opening 36 (FIG. 8) and flowing across the heat exchanger 50. Thus, when the mold 74 is not positioned beneath the drain 56, heated air cannot enter the second opening 36 to melt a crayon in the heat exchanger 50, and wax from a melted crayon cannot exit through the drain 56.

The lower portion 70 may also comprise side openings 90 (FIGS. 6 and 7) defined by the housing 110 which allow a user to look into the mold chamber 72. The openings 90 allow a user to identify the mold 74 positioned in the mold chamber 72 without having to remove it from the mold chamber 72. For example, a user may observe the general shape of the mold 74, or an indicator or label located thereon. Additionally, because the mold 74 may be substantially transparent, the user may use the side openings 90 to see how full the mold cavity 75B is, and use such information to determine whether any more crayons CN need to be melted to fill the mold 74.

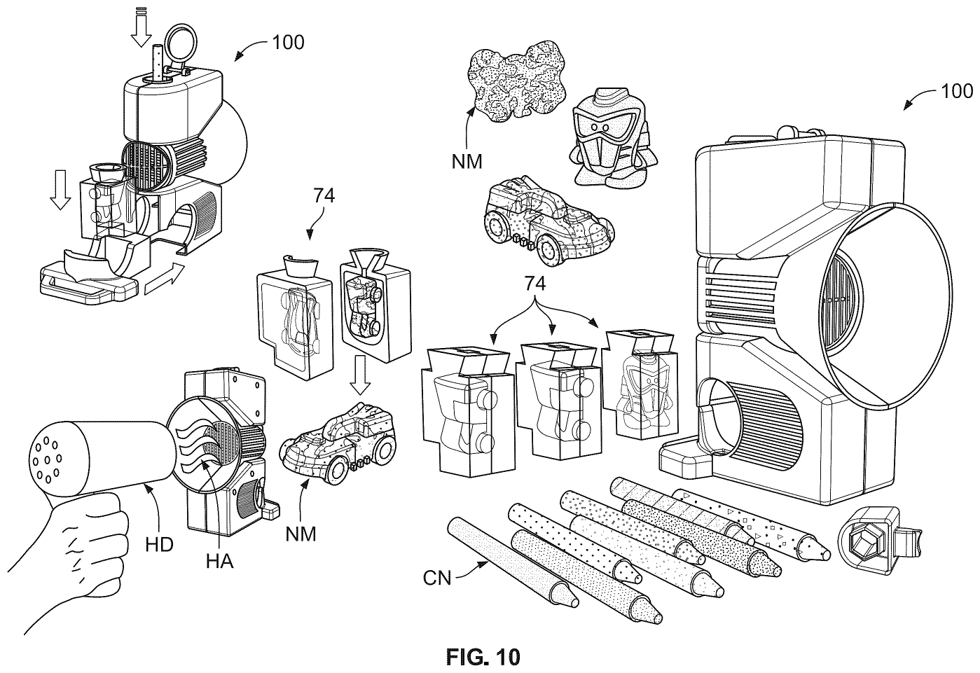

The crayon shaper 100 may come as part of a kit with a number of crayons CN and a number of different shaped molds 74, as shown in FIG. 10.

In an alternative embodiment, the crayon shaper 100 may not include the lid assembly 18, the crayon wrapper cutter 28, the second entry screen 44, or the shut-off assembly 82.

In an alternative embodiment, the mold tray 76 may include a safety post (not shown) that needs to be manually raised out of the bottom of the mold tray 76 to allow for the mold 74 to be placed in the mold tray 76. The safety post engages the shut-off plate 86 to move it to the open position when the mold tray 76 is inserted in the mold chamber 72. Thus, if a mold 74 is not placed in the mold tray 76, the shut-off plate 86 will not open when the mold tray 76 is placed in the mold chamber 72 preventing hot wax from exiting the drain 56.

In another alternative embodiment, the crayon shaper 100 may include a rotating vent system (not shown) connected to a lower rotating access door (not shown) to replace the first and second entry screens 40 and 44 and the shut-off assembly 82. In this embodiment, an upper vent ring has two vents across from each other in a linear air flow line. When the upper vent ring is rotated from a use position to a loading position, an access door is opened allowing access to the mold chamber within which the mold tray and mold are inserted. In the loading position, the upper vent ring is shut off to the two open air portals on the main housing so that heat from a hair dryer cannot enter the housing and melt a crayon in the heat exchanger. When the mold is placed in the mold tray and placed inside the lower chamber, the upper vent ring is then rotated back 90 degrees to the use position, in which the grill vent on the ring is aligned with the open air portals on the main housing to allow the hot air from the hair dryer to pass through the chamber and heat up the center mounted heat exchanger in the upper chamber.

In use, the mold tray 76 is removed from the mold chamber 72 and a mold 74 is placed in the mold tray 76, as shown in FIG. 2B. The mold tray 76 and mold 74 are then reinserted in the mold chamber 72. The cap 20 is then moved to its open position and a crayon CN is inserted through the channel mouth 14, as shown in FIG. 9. The crayon CN drops into the inner chamber 52 (FIG. 8) of the heat exchanger 50 and the cap 20 is shut. A hair dryer HD is powered on and aimed to deliver hot air HA through the funnel 32, as shown in FIG. 9. The hot air HA contacts the heat exchanger 50, which heats up and melts the crayon CN. The melted wax from the crayon drips into the mold cavity 75B (FIG. 8). It may take approximately two to three minutes to melt a crayon using a conventional hairdryer blowing hot air HA through the funnel 32. The melted wax in the mold 74 is allowed to cool and harden. The mold tray 76 and mold 74 are then removed from the mold chamber 72. The two halves of the mold 74 are separated to retrieve a new molded part NM (FIG. 10).

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A crayon shaper comprising:
a housing defining an opening configured to receive heated air and a channel configured to receive a crayon, the channel positioned so that the crayon is configured to be heated by the heated air; and
a mold positioned adjacent the channel and configured to receive portions of the crayon that are melted by the heated air.

2. The crayon shaper of claim 1, wherein the housing comprises an intake funnel defining the opening.

3. The crayon shaper of claim 1, wherein the housing comprises a heat exchanger configured to receive the crayon, the heat exchanger configured to transfer heat from heated air entering the opening to the crayon.

4. The crayon shaper of claim 3, wherein the heat exchanger defines an inner chamber aligned with the channel and configured to receive the crayon, the heat exchanger comprising a plurality of fins.

5. The crayon shaper of claim 1, further comprising a mold tray, the mold tray configured to retain the mold and detachably engage the housing such that the mold and mold tray may be removed and reinserted into the housing.

6. The crayon shaper of claim 5, wherein the housing comprises a shut-off plate movable from an open position to a closed position, in which the shut-off plate prevents the flow of the portions of the crayon that are melted by the heated air from entering the mold, the shut-off plate biased to the closed position and movable to the open position when the mold tray is inserted in the housing.

7. The crayon shaper of claim 1, wherein the housing comprises a screen positioned adjacent the opening.

8. The crayon shaper of claim 7, wherein the housing comprises a second screen positioned adjacent the screen, the second screen movable between an open position, in which heated air can enter the opening to heat a crayon in the housing, and a closed position, impeding the flow of air through the opening.

9. The crayon shaper of claim 8, further comprising a mold tray, the mold tray configured to retain the mold and detachably engage the housing such that the mold and mold tray may be removed and reinserted into the housing.

10. The crayon shaper of claim 9, wherein the second screen is configured to move from the closed position to the open position when the mold tray is inserted in the housing, and wherein the second screen is configured to move from the open position to the closed position when the mold tray is removed from the housing.

11. The crayon shaper of claim 10, wherein the housing comprises a shut-off plate movable from an open position to a closed position, in which the shut-off plate prevents the flow of the portions of the crayon that are melted by the heated air from entering the mold, the shut-off plate biased to the closed position and movable to the open position when the mold tray is inserted in the housing.
